(19) United States
(12) Patent Application Publication
(10) Pub. No.: US 2026/0182584 A1
(43) Pub. Date: Jul. 2, 2026

(54) EXTRACT AND METHOD FOR PRODUCING SAME

(71) Applicant: Panasonic Holdings Corporation, Osaka (JP)

(72) Inventors: Kumiko OSAKI, Tottori (JP); Atsushi ISHIHARA, Tottori (JP); Kei TOYOTA, Osaka (JP); Ami FUKU, Osaka (JP); Toshifumi NAGINO, Osaka (JP)

(21) Appl. No.: 19/546,988

(22) Filed: Feb. 23, 2026

Related U.S. Application Data
(63) Continuation of application No. PCT/JP2024/045424, filed on Dec. 23, 2024.

(30) Foreign Application Priority Data
Jan. 30, 2024 (JP) 2024-011703

(51) Int. Cl. A01N 65/00; A01N 25/10; A01P 21/00

(52) U.S. Cl. CPC A01N 65/00; A01N 25/10; A01P 21/00

(57) ABSTRACT

To express a resistance-inducing active gene against a disease in order to reduce the disease without a synthetic agricultural chemical. A resin mixture obtained by combining a thermoplastic resin and a spent mushroom substrate is mixed with water, and the resultant is heated and filtered. In this manner, an extract is obtained. The extract is sprayed onto a plant, so that expression of a resistance-inducing active gene in the plant can increase and the resistance of the plant against a disease can increase.

### TECHNICAL FIELD

The present disclosure relates to an extract and a method for producing the extract.

### BACKGROUND ART

As a method for inhibiting a disease damage to a crop, there has been conventionally known a method using a non-volatile chemically synthesized agricultural chemical (Patent Document 1). Meanwhile, there has been known the presence of a volatile component from a mushroom having a control effect against molds and bacteria, and it has been proposed that such a volatile component is utilized as means capable of efficiently controlling molds and bacteria in air (Patent Document 2). In addition, there has been proposed a technique of stimulating, by a component extracted from a spent mushroom substrate, induction of inherent resistance of a plant. That is, this is because it has been known that a cell wall component of a mushroom is recognized as an elicitor by a plant and the resistance of such a plant is induced and stimulated (Patent Document 3).

### CITATION LIST

### Patent Document

PATENT DOCUMENT 1: Japanese Unexamined Patent Publication No. 2009-161472
PATENT DOCUMENT 2: Japanese Unexamined Patent Publication No. 2011-167073
PATENT DOCUMENT 3: Japanese Unexamined Patent Publication No. 2011-140463

### SUMMARY OF THE INVENTION

### Technical Problem

As described above, there has been proposed a technique of producing antibacterial action against molds and bacteria and utilizing such antibacterial action for plant growth. However, the agricultural chemical as described in Patent Document 1 remains in environment after use, which may affect surrounding biological environment and aquatic animals. Further, the characteristics of many currently-used disinfectants include a narrow antibacterial spectrum and high selectivity, which may lead to problems such as emergence of resistant bacteria. The volatile component disclosed in Patent Document 2 has high safety, but is volatile. For this reason, the effect thereof is limited, such as expression of the effect only in the vicinity of molds and bacteria to be disinfected. The method using the spent mushroom substrate as disclosed in Patent Document 3 is a method in which the extracted material is directly obtained from the spent mushroom substrate progressively decayed and denatured over time, and for this reason, every time an attempt is made to obtain the extracted material, a step such as a step of sterilizing the spent mushroom substrate needs to be performed in order to obtain the extracted material with a certain level of quality.

### Solution to the Problem

An extract according to the present invention is an extract from a resin mixture, which is characterized in that the resin mixture is a compound of a spent mushroom substrate and a thermoplastic resin. The resin mixture is a mixture of a resin and another material, and is formed such that the resin and the another material are not easily separated from each other and adhere to each other. The compound is formed in such a manner that the spent mushroom substrate and the thermoplastic resin are mixed with and bonded to each other such that at least part of the surface of the spent mushroom substrate closely contact the thermoplastic resin. A state in which at least part of the thermoplastic resin melted and closely contacting the spent mushroom substrate is solidified is a bonded state.

The resin mixture is preferably in a granular form. The granular form is a shape in which the shape of each constituent unit can be identified with the eyes. The granular form is generally has a diameter (longest portion) of about 0.1 mm to 15 mm, and one with a smaller diameter is called a powder form and one with a greater diameter is called a lump form.

The granular form is preferably the form of pellet, a crushed form, or the form of grain, and preferably has a longest portion of 1 mm or more and 10 mm or less. The form of pellet has a longest portion of 2 mm or more and 10 mm or less, the crushed form has a longest portion of 0.1 mm or more and less than 1 mm, and the form of grain has a longest portion of 1 mm or more and less than 2 mm.

The extract is preferably extracted using water.

The spent mushroom substrate is preferably a spent shiitake mushroom substrate, and the thermoplastic resin is preferably a polyethylene, polypropylene, or polyester resin.

The polyester resin is preferably any of polylactic acid, polybutylene adipate terephthalate, polyhydroxybutyrate polyhydroxyvalerate, polyhydroxybutyrate polyhydroxyhexanoate, polybutylene succinate, and polybutylene succinate adipate.

The weight ratio of the spent mushroom substrate in the resin mixture is preferably 10% or more and 70% or less.

A method for producing an extract according to the present invention includes a step of combining a spent mushroom substrate and a thermoplastic resin, a step of forming a compound into a granular form, a step of adding water to a granular material in the granular form and heating the water, and a step of filtering the heated water to obtain an extract.

### Advantages of the Invention

The extract of the present invention can be manufactured by combining the thermoplastic resin and the spent mushroom substrate, forming the compound into, for example, a pellet, adding water to the pellet and heating the mixture of the pellet and the water, and filtering the heated mixture. The extract is spayed onto a plant by a sprayer or the like, so that induction of resistance against a disease of the plant can be stimulated.

### BRIEF DESCRIPTION OF THE DRAWINGS

FIG. 1 shows the state of lesions of Alternaria brassicicola in Example 2.

FIG. 2 shows the state of lesions of Alternaria brassicicola in Comparative Example 2.

### DESCRIPTION OF EMBODIMENTS

Hereinafter, an embodiment of the present invention will be described in detail.

The inventor(s) of the present invention et al. conducted studies on stimulation of resistance induction for a plant by a new method using a spent mushroom substrate. As one mechanism for inhibiting infection of a plant with pathogenic bacteria, there has been known a mechanism in which β-1,3-glucan or chitin as a fungal cell wall component is decomposed by a substance induced and produced by the plant and oligosaccharides freed by the decomposition are recognized as an elicitor by the plant and express induced systemic resistance. Note that the substance induced and produced by the plant is a chitinase or β-1,3-glucanase substance. As a result of various studies, a fungal cell wall component contained in a spent mushroom substrate is used as a raw material, and an elicitor contained in an extract from the spent mushroom substrate combined with a thermoplastic resin component is utilized.

The above-described extract is not the chemically synthesized agricultural chemical as in Patent Document 1, and therefore, is safe for environment and human bodies. Moreover, the extract containing the extracted material is used, and therefore, a volatile component does not need to be handled in a vaporized state. Thus, there is no spatial limitation as disclosed in Patent Document 2. In addition, the spent mushroom substrate and the resin are combined at a high temperature, and therefore, the resultant is sterilized and is a compound in a state of the spent mushroom substrate being blocked from external air. From the spent mushroom substrate mixed with the resin, the extracted material with a certain level of quality can be stably obtained as the extract without the sterilization or the like as in Patent Document 3. Further, it has been confirmed that the extract acts as a resistance inducer against diseases of crops such as tomatoes and cabbages, which leads to the present invention.

In one example of a process of producing an extract in the present embodiment, a pellet-shaped physical mixture is first obtained by physically mixing a thermoplastic resin and a spent mushroom substrate. Then, using a device capable of hot-melting the thermoplastic resin and mixing and kneading the thermoplastic resin with the spent mushroom substrate, such as a single-screw kneader, a double-screw kneader, or a Banbury mixer, the physical mixture is kneaded while being heated, and in this manner, a resin mixture is produced. The resin mixture is obtained in such a manner that a resin component and other components (here, spent mushroom substrate) are kneaded while at least part of the resin component is hot-melted and these components closely contact each other and are bonded to each other. Further, the resin mixture is formed into a pellet. This pellet is mixed with water, and the resultant is heated by an autoclave or the like and is then filtered. By such a production process, the extract is obtained. The extract is sprayed onto, for example, a tomato seedling with a sprayer or the like, so that a tomato can express a resistance related gene against a disease.

### (1) Raw Material

### (Thermoplastic Resin)

The thermoplastic resin as a raw material in the present embodiment is not limited to a specific resin, and is only required to be a resin which can be hot-melted by heating and be bonded to the spent mushroom substrate. Plural types of thermoplastic resins may be mixed. Examples of the thermoplastic resin include polyethylene, polyvinyl chloride, polypropylene, polystyrene, acrylonitrile-butadiene-styrene copolymer, acrylonitrile-styrene copolymer, polymethylmethacrylate, polybutylene telephthalate, polyethylene terephthalate, polylactic acid, polybutylene adipate terephthalate, polyhydroxybutyrate polyhydroxyvalerate, polyhydroxybutyrate polyhydroxyhexanoate, polybutylene succinate, polybutylene succinate adipate, polyamide, polyoxymethylene, polyvinyl alcohol, polyphenylene ether, polycarbonate, polyphenylene sulfide, aromatic polyether ketone, and polyimide. Particularly, thermoplastic resins having a softening temperature of 150° C. or more and 250° C. or less are preferable because these resins can be easily melted at the time of production and have thermal stability at the time of use. Among these resins, polypropylene and polyethylene are preferable because these resins can be generally used and have excellent moldability. Polylactic acid, polybutylene adipate terephthalate, polyhydroxybutyrate polyhydroxyvalerate, polyhydroxybutyrate polyhydroxyhexanoate, polybutylene succinate, polybutylene succinate adipate, and the like can be suitably used because these resins are biodegradable and have a less burden on environment. Plural types of these resins may be mixed and used.

### (Spent Mushroom Substrate)

The spent mushroom substrate is a used mushroom substrate after a mushroom spawn is planted in a mushroom substrate such as a raw wood of a broad-leaf tree and a mushroom is grown and harvested. The type of spent mushroom substrate used for the present embodiment is not limited, and a spent mushroom substrate after an edible mushroom is grown can be used. Examples of the mushroom substrate include a tree itself and one obtained by mixing sawdust (wood powder) with rice bran or the like. The type of mushroom is not particularly limited, and may be a shiitake mushroom, a maitake mushroom, or the like. A spent shiitake mushroom substrate (bed log after a shiitake mushroom is grown) can be suitably used because such a substrate is generally easily obtainable.

### (Water)

As the water to be mixed with the resin mixture for extraction, tap water, distilled water, ion-exchanged water, or the like can be used because water which is not mixed with bacteria is preferable. Distilled water or ion-exchanged water is further preferable because such water contains less impurities and variation in the quality of the extract by production can be reduced.

### (2) Production Method

### (Method for Producing Resin Mixture)

As the method for producing the resin mixture in the embodiment, a method can be employed as an example, in which a specific amount of thermoplastic resin and a specific amount of spent mushroom substrate are mixed into a mixture and the thermoplastic resin is hot-melted, kneaded, and cooled.

Before mixing, the spent mushroom substrate is dried for approximately 48 hours at 80° C. or more and 100° C. or less in a drying furnace until the moisture percentage thereof reaches 60% or less (first spent mushroom substrate drying step). In a case where the moisture percentage is higher than 60%, cohesion of the spent mushroom substrate is strong, and it is difficult to be crushed in a later-described spent mushroom substrate crushing step. At a temperature lower than 80° C., it takes too much time to dry the spent mushroom substrate, which leads to degradation of productivity. At a temperature higher than 100° C., strong odor is caused during drying, which is not preferable because working environment is deteriorated. The moisture percentage can be measured by a weight loss method or the like, and in order to uniformly dry the spent mushroom substrate, the spent mushroom substrate is preferably manually stirred every 12 hours during drying, for example.

In the spent mushroom substrate crushing step, the dried spent mushroom substrate is crushed by a well-known crusher, the resultant is classified with a screen of 3 mm or 3 mm or less, and the spent mushroom substrate having a longest portion of greater than 3 mm is excluded. The crusher is not limited, and a well-known crusher such as a roller mill, a jet mill, a hammer mill, a pin mill, a rotary mill, a vibration mill, a planetary mill, or a wonder crusher can be used. If a spent mushroom substrate of 3 mm or more remains, a large spent mushroom substrate lump is mixed when combined into the resin in a later-described combining step, which interferes with uniform combination and increases the spent mushroom substrate exposed to the outside of a pellet at the time of pellet formation. If a greater amount of spent mushroom substrate having a portion exposed from the pellet is contained, the exposed portion is exposed to moisture, oxygen, and bacteria in air when the pellet is stored for a long period of time, which easily alters the quality of the spent mushroom substrate.

The spent mushroom substrate after the classification is further dried at 80° C. or more and 100° C. or less until the moisture percentage thereof reaches 5% (second spent mushroom substrate drying step). If the moisture percentage is greater than 5%, it is not preferable because an error in the blending weight of the spent mushroom substrate increases in a kneading step, which makes it difficult to perform blending in a specific amount, and cohesion of the particles of the spent mushroom substrate becomes stronger, which makes it difficult to achieve uniform combination.

In order to mix the spent mushroom substrate after the above-described drying and crushing steps and the thermoplastic resin, there are a method in which the compositions of the spent mushroom substrate and the thermoplastic resin are weighed on a container, a bag, or the like and are manually mixed using a spatula or a rod-shaped jig which can be used for stirring, a method in which the spent mushroom substrate and the thermoplastic resin are substantially uniformly mechanically mixed using a rotary mixer such as a Henschel mixer, and the like (mixing step). As the thermoplastic resin and the spent mushroom substrate prepared for mixing, both these materials are preferably in the form of powder, or the thermoplastic resin is preferably in the form of pellet because the mixing step is facilitated.

For the hot-melt mixing and the kneading, the uniformly-mixed mixture can be hot-melt mixed and kneaded using a single-screw kneader, a double-screw kneader, a roll kneader, a kneader, a Banbury mixer, or the combination thereof (combining step). A temperature at the time of the hot-melt mixing is only required to be substantially equal to or higher than the melting point of the resin to be used, and for example, may be 190° C. or more in the case of polypropylene. Preferably, the upper limit of the temperature does not exceed 250° C. If the temperature exceeds 250° C., such a temperature is not preferable because an organic component contained in the spent mushroom substrate is oxidized or thermally deteriorated.

By such combination, the spent mushroom substrate increases in temperature, which exterminates bacteria and the like, and a large portion of the surface of the spent mushroom substrate is covered with the thermoplastic resin and is blocked from air. Thus, the state (including a moisture content, a sterilization state, and the like) of the spent mushroom substrate is maintained stable for a long period of time.

When the resin mixture after the hot-melt mixing is formed into pellets, the resin immediately after the melt mixing is formed into pellets or grains before cooling, and thereafter, these pellets or grains are cooled. In this manner, the resin mixture (compound) of the present embodiment can be formed.

As one example of a specific method for producing the pellets of the resin mixture, the molten mixture is stretched into a string-shaped strand before cooling, and the strand is cooled while being appropriately cut into grains by a rotary strand cutter or the like. In this manner, the pellets or the grains can be produced. The diameter of the strand may be 0.1 mm or more and 10 mm or less. Particularly, those with a diameter of 1 mm or more and less than 2 mm are called grains, and those with a diameter of 2 mm or more and 10 mm or less are called pellets. The pellet or the grain indicates a granular material. In the present embodiment, a material containing the crushed spent mushroom substrate such that at least part of the surface thereof closely contacts the resin and mixed such that the crushed spent mushroom substrate and the resin close contact each other is called a compound. That is, in the present embodiment, the above-described compound in the form of grain with a diameter of 2 mm or more and 10 mm or less is called a pellet.

The granular material preferably has a longest portion of 0.1 mm or more and 10 mm or less. If the longest portion is less than 0.1 mm, a great amount of spent mushroom substrate having a portion exposed from the granular material is contained, and such an exposed portion is exposed to moisture, oxygen, and bacteria in air when the granular material is stored for a long period of time, which easily alters the quality of the spent mushroom substrate. If the longest portion exceeds 10 mm, it is not preferable because the area where the mixture with the water contacts the water is small at the time of production of the extract described later and the amount of extracted material in the extract is small. In the brown granular material combined with the spent mushroom substrate, the spent mushroom substrate is substantially uniformly combined, and the thermoplastic resin and the spent mushroom substrate at least partially closely contact each other.

Depending on the intended use, other additives such as a pigment and a flame-retardant may be appropriately added to the mixture of the thermoplastic resin and the spent mushroom substrate, which is introduced into the hot-melt mixing machine. The weight ratio of the spent mushroom substrate in the resin mixture may be 10% by mass or more and 70% by mass or less. If the weight ratio is less than 10% by mass, sufficient resistance-inducing activity cannot be obtained in the later-described extract. If the weight ratio exceeds 70% by mass, it is difficult to produce the uniform resin mixture due to cohesion of the spent mushroom substrate or the like in the step of producing the resin mixture. Because excellent productivity can be provided and the spent mushroom substrate can be contained at a higher concentration, the weight ratio of the spent mushroom substrate in the resin mixture is more preferably 30% by mass or more and 60% by mass or less.

A heating temperature at the time of production may be the melting point of the resin to be used or more. When the heating temperature is approximately 100° C. or more, preferably 120° C. or more, the spent mushroom substrate can also be sterilized simultaneously. In addition, the spent mushroom substrate is covered with the thermoplastic resin at the same time as the sterilization, so that adhesion of bacteria to the spent mushroom substrate, oxidation degradation of the spent mushroom substrate, alteration of the quality of the spent mushroom substrate due to water absorption, and the like, which may occur afterward, can be reduced.

### (Method for Producing Extract)

As the method for producing the extract, a method can be described as an example, in which the mixture (extraction mixture) of the resin mixture and the water is formed and the mixture is heated and is then filtered using a filter such as a gauze. In the mixing of the resin mixture and the water, a weight ratio between the resin mixture and the water may be 1 part by weight to 100 parts by weight of water with respect to 1 part by weight of resin mixture. If the water is less than 1 part by weight, it is not preferable in terms of productivity because the amount of later-described extract obtained with respect to the amount of produced resin mixture is extremely small. If the water exceeds 100 parts by weight, it is not preferable because the concentration of the extract as an aqueous solution is extremely low and sufficient resistance-inducing activity cannot be obtained.

As the method of heating the mixture of the resin mixture and the water, a well-known method may be used, and the extraction mixture may be introduced into a glass tool such as a beaker and thereafter heating may be performed by a water bath, an oil bath, combustion heat of fuel, or the like. Heating by sealed heating using an autoclave or the like is preferable because a slight amount of bacteria mixed into the mixture can also be reliably sterilized while evaporation of the water is reduced. A heat temperature may be 80° C. or more and 100° C. or less. When the autoclave is used, the heating temperature is preferably set to 100° C. or more and the melting point of the thermoplastic resin or less. For example, the heating temperature is preferably 100° C. or more and 125° C. or less because such a temperature falls below the melting points of many thermoplastic resins and the sterilization can be reliably performed. A heating time may be 5 minutes or more and 60 minutes or less. If the heating time is shorter than 5 minutes, it is not preferable because a sufficient concentration of the extract for producing the effects is not obtained. If the heating time is longer than 60 minutes, it is not preferable because the concentration of the extract is saturated, which may alter the quality of the extract due to heat and may degrade the productivity.

Hereinafter, examples will be specifically described.

### Example 1

### <Production of Resin Mixture>

Polylactic acid was used as a thermoplastic resin, a spent shiitake mushroom substrate used for growing a shiitake mushroom was used as a spent mushroom substrate, and a resin mixture was produced in the following manner.

As polylactic acid, TE-2000 (product name produced by Unitika Ltd.) was used. The spent shiitake mushroom substrate (bed log) was used as the spent mushroom substrate, was crushed into particles with a particle size of φ3 mm or less by a universal crusher (SF-1 produced by Sanriki Co., Ltd.), and was dried until the moisture content thereof reaches 4%. Polylactic acid of 90 g and a spent mushroom substrate of 110 g were blended in a container, and were manually stirred and mixed using a spatula. After the stirring and the mixing, the resultant was hot-melt mixed and kneaded. A double-screw kneader (KRC kneader produced by Kurimoto, Ltd.) was used for the hot-melt mixing and the kneading, a temperature was set to 200° C., and the number of rotations was set to 50 rotations/min. A strand-shaped resin mixture obtained through an outlet port was cut into a length of about 5 mm, and in this manner, a pellet-shaped resin mixture (compound) of the spent mushroom substrate and polylactic acid was obtained.

### <Production of Extract>

A mixture of resin mixture pellets, which were obtained in the above-described step, of 2 g and distilled water of 10 ml was placed in an autoclave, was processed at 121° C. for 10 minutes, and was filtered using a gauze. In this manner, an extract of the present example was obtained.

### <Analysis of Expression of Disease Resistance Related Gene>

For a tomato seedling, expression of a disease resistance related gene was analyzed in the following steps. The tomato seedling was planted in a black pot having therein soil for flowers and vegetables and vermiculite-mixed soil (1:1). An extract of 1 mL was sprayed onto each of five one-month-old tomato seedlings. Two leaves were cut out from each of three of the seedlings a day after the spraying, and were stored at −80° C. RNA was extracted from the collected leaf samples. The concentration of the RNA was adjusted, reverse transcription of the RNA was performed, and cDNA was synthesized. Real-time PCR was performed using each specific primer of the disease resistance related genes (Glu-A, Glu-B, CHI3, CHI9), and the amount of expression of each gene was analyzed.

### Example 2

Production of a resin mixture and production of an extract were similar to those of Example 1 above, and expression of resistance was verified as follows.

### <Verification of Expression of Resistance>

For a cabbage (breed: syosyu), the expression of the resistance was verifies in the following steps. The cabbage was grown for four weeks in soil for flowers and vegetables and vermiculite-mixed soil (1:1). Five cabbages were prepared for each experimental section, and the extract of 5 ml was spray inoculated per experimental section. Next, the cabbage was left to stand in a plastic container with water, and 24 hours later or 48 hours later, an Alternaria brassicicola 0264 spore suspension (5×10⁵ spores/ml) of 5 ml was spray inoculated per experimental section. Then, the cabbage spray inoculated with the Alternaria brassicicola 0264 spore suspension was left to stand in a plastic container with water, and 24 hours later, formation of a leaf lesion was checked. A leaf area was calculated using graph paper, and the number of lesions per cm² was calculated using the following formula:

Number of lesions (lesions/cm²)=Number of lesions per leaf+Leaf area (cm²)

### Example 3

In Example 3, production of a resin mixture (composition), production of an extract, and analysis of expression of a disease resistance related gene were performed similarly to Example 1, except that a spent mushroom substrate was a spent nameko mushroom substrate.

### Comparative Example 1

In Comparative Example 1, analysis of expression of a disease resistance related gene was performed for a tomato seedling similarly to Example 1, except that no extract was sprayed.

### Comparative Example 2

In Comparative Example 2, expression of resistance was verified for a cabbage similar to Example 2, except that no extract was sprayed.

The analysis results of the resistance related genes Glu-A, Glu-B, CHI3, CHI9 of the tomato in Examples 1 and 3 above and Comparative Example 1 are shown in Table 1. Table 1 shows whether or not a significant difference of 5%, 1%, or 0.01% level was confirmed as compared to Comparative Example 1 in a t-test.

TABLE 1

| | Glu-A | Glu-B | CHI3 | CHI9 |
|---|---|---|---|---|
| Comparative | Reference | Reference | Reference | Reference |
| Example 1 | | | | |
| Example 1 | 5% | 5% | 1% | 0.01% |
| Example 3 | 1% | No Significant | Not | Not |
| | | Difference | Performed | Performed |

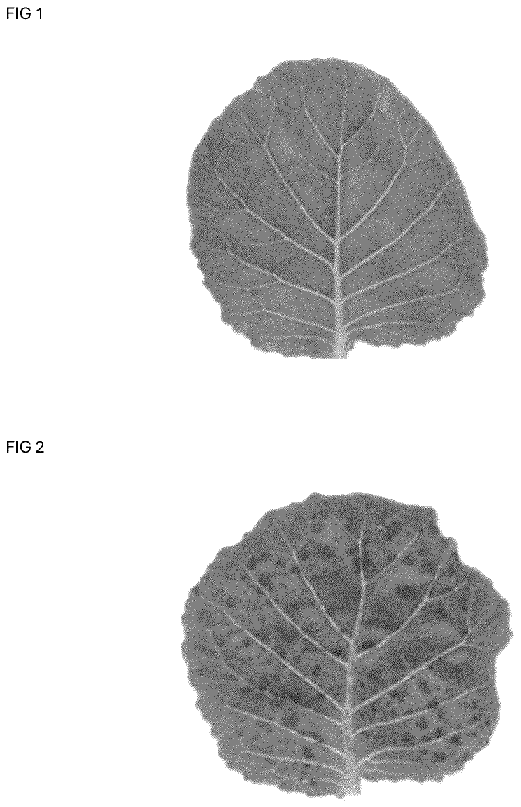

The state of the lesions of the Alternaria brassicicola of the cabbage with the sprayed extract in Example 2 is shown in FIG. 1, and the state of the lesions of the Alternaria brassicicola of the cabbage with no sprayed extract in Comparative Example 2 is shown in FIG. 2.

For the Glu-A gene, Table 1 shows that in a case where the extract obtained from the resin mixture combined with the spent shiitake mushroom substrate is sprayed onto the tomato seedling, that is, in Example 1, there is a significant difference of 5% level in expression amount from Comparative Example 1. It is also shown that in Example 3, there is a significant difference of 1% level in expression amount from Comparative Example 1.

For the Glu-B gene, it is shown that only in Example 1, there is a significant difference of 5% level in expression amount. There is no significant difference in Example 3, but it does not mean that there is no effect for the expression amount at all.

For the CHI3 gene, it is shown that only in Example 1, there is a significant difference of 1% in expression amount. For the CHI9 gene, it is shown that in Example 1, there is a noticeable significant difference of 0.01% level in expression amount.

Comparison between FIGS. 1 and 2 shows that the number of lesions of the Alternaria brassicicola is smaller in the leaf of the cabbage sprayed with the extract, that is, in Example 2, and the number of lesions of the Alternaria brassicicola is greater in the leaf of the cabbage sprayed with no extract, that is, in Comparative Example 2. A disease reduction rate when the extract is sprayed, which was estimated from each number of lesions, was 78.9%. It can be said that such a rate is a result of the expression of the resistance related gene in the cabbage sprayed with the extract.

As described above, in verification of reduction in the disease of the tomato, only in Example 1, there was the significant difference in the expression amount from Comparative Example 1 without spraying or the like for any of the resistance related genes Glu-A, Glu-B, CHI3, CHI9. Moreover, it is shown that the extract obtained from the resin mixture combined with the spent shiitake mushroom substrate is effective for the expression of the resistance related gene against the disease. Note that also in Example 3, there was the significant difference in the expression amount from Comparative Example 1 without spraying or the like for the resistance related gene Glu-A. Verification of reduction in the disease of the cabbage shows that as seen from Example 2 and Comparative Example 2, the extract obtained from the resin mixture combined with the spent shiitake mushroom substrate is effective for the reduction in the disease.

### OTHER EMBODIMENTS

The above-described embodiments are examples of the invention of the present application, and the invention of the present application is not limited thereto. A well-known technique, a conventional technique, or a publicly-known technique may be combined with these examples, or some of these examples are replaced therewith. Modifications easily conceivable by those skilled in the art are also included in the invention of the present application.

1. An extract from a resin mixture, the resin mixture being a compound of a spent mushroom substrate and a thermoplastic resin.

2. The extract of claim 1, wherein
the resin mixture is in a granular form.

3. The extract of claim 2, wherein
the granular form is a form of pellet, a crushed form, or a form of grain, and has a longest portion of 1 mm or more and 10 mm or less.

4. The extract of claim 1, wherein
the extract is extracted using water.

5. The extract of claim 1, wherein
the spent mushroom substrate is a spent shiitake mushroom substrate, and the thermoplastic resin is a polyethylene, polypropylene, or polyester resin.

6. The extract of claim 5, wherein
the polyester resin is any of polylactic acid, polybutylene adipate terephthalate, polyhydroxybutyrate polyhydroxyvalerate, polyhydroxybutyrate polyhydroxyhexanoate, polybutylene succinate, and polybutylene succinate adipate.

7. The extract of claim 1, wherein
a weight ratio of the spent mushroom substrate in the resin mixture is 10% or more and 70% or less.

8. A method for producing an extract, comprising:
a step of combining a spent mushroom substrate and a thermoplastic resin;
a step of forming a compound into a granular form;
a step of adding water to a granular material in the granular form and heating the water; and
a step of filtering the heated water to obtain an extract.
